(19) United States
(12) Patent Application Publication
(10) Pub. No.: US 2005/0218121 A1
(43) Pub. Date: Oct. 6, 2005

(54) Resistance welding method of different kinds of materials, and resistance welding member of aluminum alloy material and different kind of material

(76) Inventors: Noboru Hayashi, Saitama (JP); Hitoshi Kazama, Saitama (JP); Wataru Oikawa, Tochigi (JP)

Correspondence Address: ARENT FOX PLLC, 1050 CONNECTICUT AVENUE, N.W., SUITE 400, WASHINGTON, DC, 20036, US

(21) Appl. No.: 11/087,737

(22) Filed: Mar. 24, 2005

(30) Foreign Application Priority Data
Apr. 2, 2004 (JP) 2004-110342

(51) Int. Cl. B32B 15/20; B23K 11/16

(52) U.S. Cl. 219/118; 428/653

(57) ABSTRACT

The resistance welding method of different kinds of materials is the method for welding an iron material and an aluminum alloy material, and comprises the steps of: performing in advance a coating treatment at least to a portion of the aluminum alloy material, where resistance welding is performed, with any of iron and iron-base alloy and forming a surface layer; and performing resistance welding of the iron material and the aluminum alloy material through the surface layer, and the resistance welding may be any of spot welding and projection welding.

### BACKGROUND OF THE INVENTION

1. Field of the Invention

The present invention relates to a resistance welding method of different kinds of materials of connecting a steel material and an aluminum alloy material by resistance welding, and a resistance welding member of the aluminum alloy material and a different kind of material.

2. Description of the Related Art

Conventionally, in a vehicle body of an automobile and the like is generally used such a steel sheet of an iron group material. On the other hand, a weight saving of the vehicle body is desired by improving a fuel consumption rate and reinforcing a regulation of an exhaust gas, and for example, it is considered to separately use the steel sheet and the like and a lighter material such as an aluminum alloy sheet, depending a portion of the vehicle body.

In assembling a vehicle, using such the materials, it is generally performed to respectively connect steel sheets and aluminum alloy sheets with spot welding by a robot and the like. However, because the spot welding of the aluminum alloy sheets needs a current and electrode force larger than those of the steel sheets, a connection cannot be performed by welding equipment used for a welding of the steel sheets. Accordingly, it is necessary to separately provide special welding equipment for the aluminum alloy sheets each other. Additionally, in the spot welding of the aluminum alloy sheets there occurs some electrode wear of aluminum alloy's appearing on a surface thereof, alloying with an electrode, being deposited, a shape of an electrode tip changing, and the like. Because if such the wear occurs, a resistance value changes due to the change of an electrode shape, a preferable welding cannot be performed, and thereby there is a problem that continuous spot weldability becomes short. Therefore, in welding the aluminum alloy sheets it is necessary to frequently dress the electrode tip.

Meanwhile, with respect to the continuous spot weldability, as a technology for heightening the weldability is disclosed an aluminum alloy sheet where a plating of a main constituent of nickel is treated on a face opposing an electrode (for example, see paragraphs 0008 to 0011 of Japanese Patent Laid-Open Publication Hei. 5-5189).

In addition, as a technology for making the continuous spot weldability and a welding current value equivalent to or near those of a steel sheet is disclosed an aluminum alloy sheet where a Zn—Fe group alloy plating layer is made a predetermined plating adhesion amount (for example, see paragraphs 0012 to 0015 of Japanese Patent Laid-Open Publication Hei. 6-73592).

However, although the conventional technologies described above can perform spot welding of respective materials of such steel sheets and aluminum alloy sheets, it does not go well to perform a different-kind-connection of an iron material and an aluminum alloy material by resistance welding such as the spot welding, and in a present situation it does not go as far as a practical use.

Consequently, followings are strongly requested: a resistance welding method of different kinds of materials of: being able to connect a steel sheet and an aluminum alloy sheet and to use existing welding equipment as it is, furthermore, being excellent in continuous spot weldability, and being able to reduce a maintenance frequency of an electrode; and a resistance welding member of an aluminum alloy material and a different kind of material that can perform a different-kind-connection of a iron material and the aluminum alloy material.

### SUMMARY OF THE INVENTION

The inventors have devoted themselves to study a resistance welding method of different kinds of materials for welding an iron material and an aluminum alloy material and, as the result, have found that the problem described above is solved by performing a coating treatment to the aluminum alloy material with any of iron and iron-base alloy and thereby forming a surface layer, and then performing resistance welding with the iron material.

The present invention is realized on the basis of such the knowledge, and the resistance welding method of different kinds of materials is the method of the different kinds of the materials for welding an iron material and an aluminum alloy material, the method comprising the steps of: performing in advance a coating treatment at least to a portion of the aluminum alloy material, where resistance welding is performed, with any of iron and iron-base alloy and forming a surface layer; and performing the resistance welding of the iron material and the aluminum alloy material through the surface layer (first aspect of the present invention).

In accordance with the present invention, because the iron material and the aluminum alloy material are designed to be welded through the surface layer formed by a coating treatment's being performed with any of the iron and the iron-base alloy, there occurs a resistance heat generation between the iron material and the surface layer, and the iron material and the aluminum alloy material connect at an interface thereof. At this time, by the resistance heat generation at an iron material side the aluminum alloy material melts, a nugget is produced at an aluminum alloy material side, and thereby the different kinds of materials of the iron material and the aluminum alloy material are connected. Thus in spite of the resistance welding of different kinds of materials of the iron material and the aluminum alloy material, it is enabled to perform the welding, using existing welding equipment for the iron material (steel sheet and the like) as it is, and thereby weldability of the iron material and the aluminum alloy material can be remarkably improved.

Furthermore, in the resistance welding there is no rapid rise of a surface temperature of the aluminum alloy material, and a deposition between the aluminum alloy material and an electrode (made of copper alloy) becomes difficult to occur. Thus an electrode life by continuous spot welding becomes long, and thereby a maintenance frequency of the electrode can be reduced. In other words, the continuous spot weldability is same as that of welding iron materials each other or rather surpassing it.

Meanwhile, the “weldability” signifies, in a welding connection portion after a welding, that a good welding connection state such that an excellent mechanical strength can be ensured can be obtained.

In addition, although the surface layer by the coating treatment is necessary to be formed at least for a contact face with the iron material, it is available to be formed at a side where the electrode contacts. In this case a merit can be obtained that a nugget of melted aluminum alloy does not appear on a surface side, and accordingly, a phenomenon is prevented that the melted aluminum alloy is alloyed with the electrode. Thus electrode wear is suppressed, and thereby the continuous spot weldability (electrode life) can be heightened. In addition, an appearance of a welded portion can be made good, and thus a product quality can be heightened.

Furthermore, by performing the coating treatment with any of iron and iron-base alloy, a magnetic-force-receiving layer results in being formed in the surface layer of the aluminum alloy material. Accordingly, for example, by forming the surface layer across any of a wide range of surface of an aluminum alloy material and substantially all the surface, the aluminum alloy material is obtained that can be conveyed by a jig utilizing magnetic force.

Accordingly, even a weighty product can be conveyed without using equipment such as a conventional high pressure air conveyance, and thereby an advantage is obtained that handling easiness between each process becomes heightened. Thus an improvement of productivity can be realized. In addition, the surface layer is formed by the coating treatment, and thereby a damage resistance property becomes heightened. In addition, it is preferable to thinly form the surface layer, and thereby, even when using a magnetic force jig, there is no residual magnetism in an aluminum alloy material: the product can also be easily detached from the magnetic force jig.

Meanwhile, as the coating treatment can be cited, for example, a plating treatment, a sputtering treatment, a metal vapor deposition treatment, and the like. It is particularly preferable to form the surface layer by the plating treatment.

Furthermore, as resistance welding can be adopted any of spot welding and projection welding (second aspect of the present invention). Because a production system adopting the spot welding can be automated and construct a production line matching the automation, it is suitable for a welding method of different kinds of materials of an iron material and an aluminum alloy material in the present invention.

In addition, iron-base alloy is composed so that an Fe containing ratio thereof is made not less than 60% (third aspect of the present invention). If the Fe containing ratio of the iron-base alloy is less than 60%, an effect of improving weldability cannot be obtained. In addition, it becomes easy to have a disadvantage for workability and a conveyance utilizing a magnetic force jig, and thus an efficiency of a manufacturing process cannot be realized.

Furthermore, a surface layer of an aluminum alloy material is composed so that a thickness thereof is formed in a range of 0.01 to 40 μm (fourth aspect of the present invention). If the thickness of the surface layer is less than 0.01 μm, a resistance heat generation occurring between an iron material and the surface layer lowers, a connection at an interface weakens, and thus weldability becomes easy to lower. On the other hand, if the thickness of the surface layer becomes over 40 μm, a nugget is not sufficiently produced at an aluminum alloy material side, a connection of the iron material and the aluminum alloy material becomes insufficient, and thus toughness lowers.

In addition, iron-base alloy is composed so as to contain at least one kind out of Cr, Zn, Ti, Sn, Ni, Mn, Co, Cu, Mo, and Si (fifth aspect of the present invention). Thus a surface layer of an aluminum alloy material can be composed of the iron-base alloy containing the one kind, and it is enabled to perform resistance welding, bringing each property (application) into play. In addition, a selection of the elements becomes easy, and thereby a working property is heightened.

Furthermore, iron-base alloy can be composed of an Fe—Cr group alloy (sixth aspect of the present invention). Thus a surface layer of an aluminum alloy material can be composed of the Fe—Cr group alloy, is higher in hardness, it is enabled to perform resistance welding, and a damage resistance property of aluminum alloy is improved.

In addition, an aluminum alloy material of the present invention is the material used for a resistance welding method of the different kinds of the materials and comprises a surface layer formed in advance at least at a portion, where resistance welding is performed, by a coating treatment with any of iron and iron-base alloy (seventh aspect of the present invention).

Such the aluminum alloy material comprises the surface layer formed in advance at least at the portion, where the resistance welding is performed, by the coating treatment with any of the iron and the iron-base alloy, the resistance welding of the different kinds of the materials with an iron material can be performed through the surface layer. In addition, by forming the surface layer by the coating treatment at a side which an electrode contacts, because a contact between a melted aluminum nugget and the electrode is prevented in the surface layer, a deposition of the nugget and the electrode (made of copper alloy), and thereby an electrode life by continuous spot welding becomes longer. Thus a maintenance frequency of the electrode is reduced. Accordingly, the aluminum alloy material excellent in weldability is obtained.

In addition, by the surface layer being formed is obtained the aluminum alloy material excellent in a damage resistance property and further in handling easiness by a magnetic force jig.

Furthermore, a resistance welding member of different kinds of materials of the present invention is that of different kinds of materials of an iron material and an aluminum alloy material obtained by using a resistance welding method of the different kinds of the materials; comprises a surface layer formed in advance at least at a portion of the aluminum alloy material, where resistance welding is performed, by a coating treatment with any of iron and iron-base alloy; and the iron material and the aluminum alloy material are welded by the resistance welding through the surface layer (eighth aspect of the present invention).

In accordance with the resistance welding member of the different kinds of the materials, a resistance heat generation occurs between the iron material and the surface layer in the resistance welding, and thereby it is obtained the resistance welding member of the different kinds of the materials where iron and aluminum alloy are connected at an interface thereof. Furthermore, by forming the surface layer by the coating treatment at a side which an electrode contacts, a contact between a nugget of the melted aluminum alloy material and the electrode becomes enabled to be prevented by the surface layer, and thus it is obtained the resistance welding member where a deposition of the nugget and the electrode (made of copper alloy) is difficult to occur and continuous spot weldability is improved.

In addition, by the surface layer's being formed is obtained the aluminum alloy material excellent in a damage resistance property and further in handling easiness by a magnetic force jig.

### BRIEF DESCRIPTION OF THE DRAWINGS

FIGS. 1A to 1D are schematic section drawings illustrating a resistance welding method of different kinds of materials related to an embodiment of the present invention.

FIG. 2 is a schematic drawing showing a conveyance of an aluminum alloy sheet by a jig utilizing magnetic force.

FIG. 3 is an illustration showing a welding of an aluminum alloy sheet and steel sheet having no coating treatment.

FIG. 4 is a drawing showing a condition of image of a nugget section structure taken by an electron microscope with respect to an example 3 shown in Table 1.

FIG. 5 is a schematic drawing of FIG. 4.

FIG. 6 is an enlarged drawing showing an interface of an aluminum alloy sheet and a steel sheet shown in FIG. 4.

FIG. 7 is a schematic drawing of FIG. 6.

FIG. 8 is a further enlarged drawing showing the interface of FIG. 6 by a transmission electron microscope.

FIG. 9 is a schematic drawing of FIG. 8.

FIG. 10 is a drawing showing a condition of image of a whole nugget section structure taken by an electron microscope.

FIG. 11 is a schematic drawing of FIG. 10.

FIG. 12 is a drawing showing a condition of image of a whole nugget section structure of spot welding taken by an electron microscope when a three-layer structure is made by stacking two steel sheets on an aluminum alloy sheet in the spot welding.

FIG. 13 is a schematic drawing of FIG. 12.

### DESCRIPTION OF THE PREFERRED EMBODIMENTS

Here will be described a resistance welding method related to one embodiment of the present invention. The resistance welding method of different kinds of materials of the embodiment is the method of the different kinds of the materials for welding an iron material and an aluminum alloy material, and comprises the steps of performing in advance a coating treatment at least to a portion of the aluminum alloy material, where resistance welding is performed, with any of iron and iron-base alloy and forming a surface layer; and performing the resistance welding of the iron material and the aluminum alloy material through the surface layer.

Here will be described an aluminum alloy sheet used for the resistance welding method of the different kinds of the materials. As described above, the aluminum alloy sheet comprises the surface layer formed by the coating treatment by the iron and the iron-base alloy, and the surface layer can be formed by a known plating treatment.

For example, an electrolysis method can be adopted as the known plating treatment. Meanwhile, advancing the coating treatment, it is preferable to perform an underplating treatment, and as the underplating treatment is adopted any of a zincate method of performing a replacement plating by an alkali-zinc bath and an anode oxidation method of performing a plating after forming an anode oxidation film of aluminum.

As the electrolysis method, for example, can be cited a method of performing a zincate treatment; then in water solution containing ferrous sulfate and trivalent chrome, making a carbon electrode plate an anode and an aluminum alloy sheet a cathode and performing a cathode-electrolysis by a current density of 3 to 5 A/dm²; and thereby being able to obtaining an Fe—Cr alloy plating.

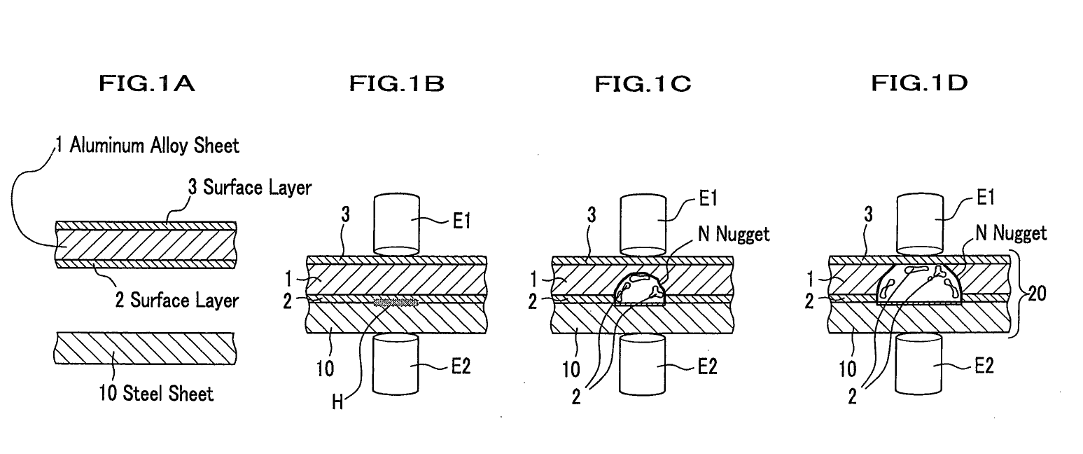

FIGS. 1A to 1D are schematic section drawings illustrating a resistance welding method of different kinds of materials related to an embodiment of the present invention. As shown in FIG. 1A, the embodiment uses an aluminum alloy sheet 1 and a steel sheet 10 as an iron material. And as resistance welding, the embodiment uses spot welding having high versatility in a manufacturing process of an automobile.

In addition, the embodiment forms surface layers 2 and 3, which consist of the Fe—Cr alloy plating, on both faces of the aluminum alloy sheet 1 by the above method.

Firstly, as shown in FIG. 1B, overlap the aluminum alloy sheet 1 and the steel sheet 10, and while holding these tight with predetermined electrode force by a pair of upper/lower electrodes E1 and E2 (made of copper alloy) of a spot welder not shown, make a current one to a few cycles flow. Meanwhile, as a welding power source of the spot welder can be used a capacitor power source, which can make a comparatively large current flow in a matter of minutes.

If the predetermined current flows with the predetermined electrode force, a resistance heat generation H occurs between the aluminum alloy sheet 1 and the steel sheet 10; after then, as shown in FIG. 1C, a side of the aluminum alloy sheet 1 melts by a resistance heat generation at a side of the steel sheet 10; and a nugget N is produced. At this time the surface layer 2 is destroyed by melting and expanding, moves by melting and being agitated, and then solidifies (see FIG. 1D). Along with this, a spacing of the surface layer 2 and the steel sheet 10 is connected by an interface thereof. Thus the aluminum alloy sheet 1 and the steel sheet 10 are connected by the spot welding, and thereby a resistance welding member 20 of different kinds of materials is formed. At this time, as shown in FIG. 1D, the nugget N (melted aluminum) is prevented from being exposed to a side of the electrode E1 thanks to an existence of the surface layer 3.

In accordance with the embodiment, because the aluminum alloy sheet 1 and the steel sheet 10 are designed to be welded through the surface layer 2 (or the surface layer 3) formed by performing a coating treatment with any of iron and iron-base alloy, the resistance heat generation H occurs between the steel sheet 10 and the surface layer 2, and thereby the steel sheet 10 and the aluminum alloy sheet 1 connects at the interface. At this time the aluminum alloy sheet 1 melts by the resistance heat generation at the side of the steel sheet 10, the nugget N is produced at the side of the aluminum alloy sheet 1, and thus the steel sheet 10 and the aluminum alloy sheet 1 of the different kinds of the materials are connected. Accordingly, welding equipment for an existing iron material (steel sheet 10) can be used as it is, and the welding of the steel sheet 10 and the aluminum alloy sheet 1 is realized.

Furthermore, because in the resistance welding a contact of the melted nugget N and the electrode E1 is prevented by the surface layer 3, a phenomenon of the nugget N being alloyed with the electrode E1 is prevented, and a wear of the electrode E1 results in being suppressed. Accordingly, a maintenance frequency of the electrode E1 (E2) can be reduced, and thereby continuous spot weldability becomes equivalent to that of the steel sheets 10 each other or surpasses it. In addition, an appearance of a welded portion can be made good, and thus a product quality can be heightened.

For example, describing this as shown in FIG. 3 in contrast with a welding of an aluminum alloy sheet 5 and the steel sheet 10 having no coating treatment, a following is assumed: even if a current used for a usual welding (welding of the steel sheets 10 each other) is made to flow through the electrodes E1 and E2, the resistance heat generation does not occur at an interface S between the aluminum alloy sheet 5 and the steel sheet 10. This can be thought because although the steel sheet 10 itself is in a condition of being welded, the aluminum alloy sheet 5 stays in a condition of a current's, which is used for a usual welding thereof, being applied, and a condition of the sheet 5's being able to be welded is not reached. Accordingly, in this state the aluminum alloy sheet 5 does not melt, and thereby the aluminum alloy sheet 5 and the steel sheet 10 are not connected by the welding.

On the other hand, as shown in FIGS. 1C and 1D, because the welding of the aluminum alloy sheet 1 and the steel sheet 10 where the coating treatment is performed becomes, as described above, the contact of iron and iron, that is, the contact of the steel sheet 10 and the surface layer 2 (surface layer 3), a resistance heat generation at an interface thereof occurs, thereby melting thereof occurs, and the welding is performed, by applying a current used for a usual welding (welding of the steel sheets 10 each other) through the electrodes E1 and E2. Thus the resistance welding member 20 of the different kinds of the materials is formed.

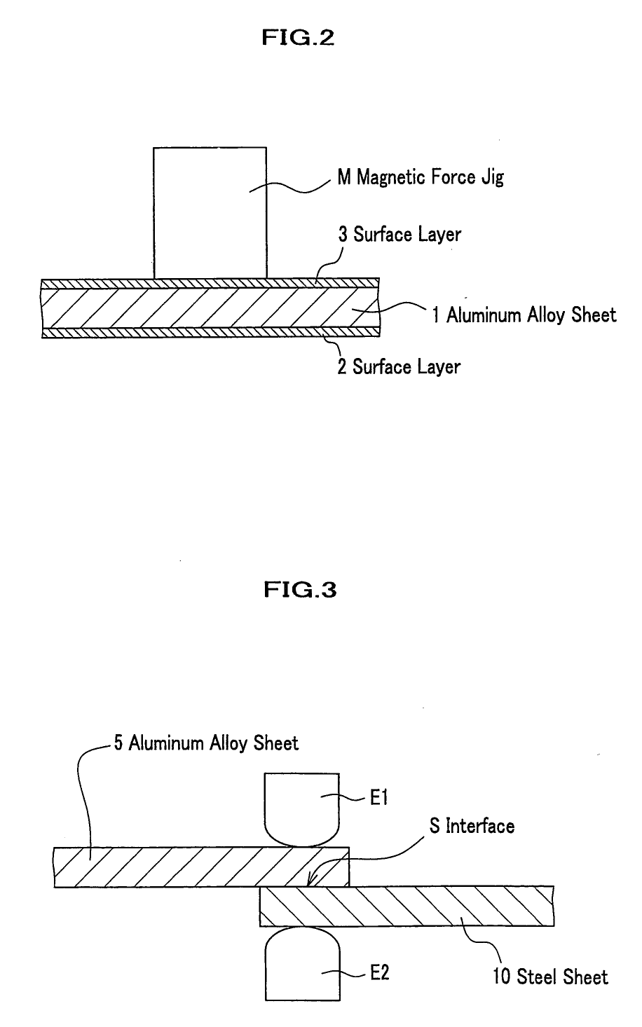

Furthermore, by forming the surface layers 2 and 3 with any of iron and iron-base alloy, a magnetic-force-receiving layer results in being formed in the aluminum alloy sheet 1: accordingly, for example, by forming the surface layers 2 and 3 across any of a wide range of surface of the aluminum alloy sheet 1 and substantially all the surface, the aluminum alloy sheet 1 that can be conveyed by a magnetic force jig M utilizing magnetic force is obtained as shown in FIG. 2.

Accordingly, even a weighty product can be conveyed without using equipment such as a conventional high pressure air conveyance, and thereby an advantage is obtained that handling easiness between each process becomes heightened. Thus an improvement of productivity can be realized. In addition, the surface layers 2 and 3 are formed by the coating treatment, and thereby a damage resistance property becomes heightened. In addition, it is preferable to thinly form the surface layers 2 and 3, and thereby, even when using the magnetic force jig M, there is no residual magnetism in the aluminum alloy sheet 1: the product can also be easily detached from the magnetic force jig M.

In addition, it is not always necessary to provide the surface layer 3 of side opposing the electrode E1 (see FIG. 1B) of the aluminum alloy sheet 1, and if the surface layer 2 of side of the steel sheet 10 is provided, the connection where weldability is improved as described above is feasible.

Furthermore, when using iron-base alloy for the surface layers 2 and 3, an Fe containing ratio thereof is composed so as to be not less than 60%. If the Fe containing ratio of the iron-base alloy is less than 60%, an effect of a weldability improvement is not obtained. In addition, it becomes easier to have a disadvantage for workability and a conveyance utilizing a magnetic force jig, and thus it becomes easier to cause a harmful effect such that an efficiency of a manufacturing process cannot be realized.

In addition, to be more precise, the surface layers 2 and 3 of the aluminum alloy sheet 1 are composed so that a thickness thereof is formed in a range of 0.01 to 40 μm. If the thickness of the surface layers 2 and 3 is less than 0.01 μm, a resistance heat generation occurring between the steel sheet 10 and the surface layer 2 (surface layer 3) lowers, a connection at an interface thereof weakens, and thus weldability becomes easier to lower. On the other hand, if the thickness of the surface layer 2 (surface layer 3) becomes more than 40 μm, the nugget M is not sufficiently produced at the side of the aluminum alloy sheet 1, the connection of the steel sheet 10 and the aluminum alloy sheet 1 becomes insufficient, thus toughness lowers, and so it is not preferable.

Furthermore, when using iron-base alloy for the surface layers 2 and 3, the iron-base alloy can be composed so as to contain at least one kind out of Cr, Zn, Ti, Sn, Ni, Mn, Co, Cu, Mo, and Si. Thus composed, the surface layers 2 and 3 of the aluminum alloy sheet 1 can be composed of the iron-base alloy containing the one kind, and it is enabled to perform resistance welding (connection), bringing each property (application) into play. In addition, a selection of the elements becomes easier, and thereby a working property is heightened.

Furthermore, iron-base alloy can be composed of an Fe—Cr group alloy. The iron-base alloy thus composed of the Fe—Cr group alloy is higher in hardness, thereby prevents damage and local deformation (deformation, dent, and the like) after pressing the aluminum alloy sheet 1, and thus an improvement of a production yield ratio and a stability of productivity can be realized.

Meanwhile, in a production system adopting the spot welding as resistance welding, an automation is enabled, and an advantage can also be obtained that a production line matching it can be constructed.

### EXAMPLE

Although here will be more concretely described the present invention, citing examples, the invention is not limited to the examples described below, and it is enabled to add changes to the examples and perform them within the spirit and scope of the invention: these are all included in a technical range of the invention.

The aluminum alloy sheet 1 was made where the surface layers 2 and 3 are formed of any of an Fe plating and various Cr containing amounts of Fe—Cr platings by dispensing a replacement Zn layer on a surface of the aluminum alloy sheet 1 with a zincate treatment; then, in water solution containing ferrous sulfate and trivalent chrome, making a carbon electrode plate an anode and the aluminum alloy sheet 1 a cathode and performing a cathode-electrolysis under each condition shown in Table 1. Each plating thickness was formed to 5 μm.

And with respect to the aluminum alloy sheet 1 obtained, matching a welding current in resistance welding an optimum value, continuous spot weldability and rupture strength were examined. The continuous spot weldability and the rupture strength were evaluated by spot welding. In addition, As steel sheets were used an SP steel sheet and a GA steel sheet (galvanized steel sheet).

[Welding Condition]

Thickness: 1.0 mm
Electrode: 16 mm φ Cu alloy containing chrome
Electrode force: Constant pressurization of 150 kgf
Welding time (current passing time): 10 cycles (50 Hz)
Current: 12 to 14 KA

The evaluation of the resistance welding property was performed by obtaining the continuous spot weldability in a state (state of a normal nugget's being formed) of the rupture strength's (1.3 KN) being ensured for realizing predetermined weldability; and by making the continuous spot weldability surpassing that (spotting number) of resistance welding of the SP sheets each other good (X) and not surpassing it bad (Δ).

In addition, as comparison examples, by welding aluminum alloy sheets where surface layers were not formed and SP steel sheets, respectively, under conditions described in Table 1, the continuous spot weldability in the state of (state of the normal nugget's being formed) of the rupture strength's (1.3 KN) being ensured for realizing the predetermined weldability was obtained. The result is shown in Table 1.

TABLE 1

| | | | | | | | Resistance Welding Property | | | | | |
|---|---|---|---|---|---|---|---|---|---|---|---|---|
| | | | | | | | | | Continuous | | | |
| | | | | | | | | | Spot | | | |
| | | Plating | | | | Plating | Welding | Electrode | Weldability | Rupture | | |
| | | Composition | | | Thickness | Thickness | Current | Force | (Spotting | Strength | | |
| | | Fe | Cr | Zn | (mm) | (μmm) | (KA) | (kgf) | Number) | (KN) | Evaluation | Remark |
| Example | 1 | 100 | 0 | — | 1.0 | 5 | 12 | 150 | 250 | 1.5 | X | SP-Al |
| | 2 | 92 | 8 | — | 1.0 | 5 | 13 | 150 | 250 | 1.7 | X | Welding |
| | 3 | 82 | 18 | — | 1.0 | 5 | 13 | 150 | 250 | 1.4 | X | |
| | 4 | 100 | 0 | — | 1.0 | 5 | 14 | 150 | 300 | 1.5 | X | GA-Al |
| | 5 | 98 | 2 | — | 1.0 | 5 | 14 | 150 | 300 | 1.4 | X | Welding |
| | 6 | 95 | 5 | — | 1.0 | 5 | 14 | 150 | 320 | 1.4 | X | |
| | 7 | 92 | 8 | — | 1.0 | 5 | 14 | 150 | 320 | 1.5 | X | |
| | 8 | 90 | 10 | — | 1.0 | 5 | 14 | 150 | 350 | 1.8 | X | |
| | 9 | 82 | 18 | — | 1.0 | 5 | 14 | 150 | 350 | 2.1 | X | |
| Comparison | 1 | — | — | 100 | 0.7 | 4 | 8 | 250 | 200 | 3.2 | X | SP-SP |
| Example | 2 | — | — | 100 | 0.7 | 4 | 9 | 250 | 200 | 3.6 | X | Welding |
| | 3 | — | — | 100 | 0.7 | 4 | 10 | 250 | 200 | 4.3 | X | |
| | 4 | — | — | — | 1.0 | — | 20 | 250 | 50 | 1.4 | Δ | Al-Al |
| | 5 | — | — | — | 1.0 | — | 22.5 | 250 | 30 | 1.9 | Δ | Welding |
| | 6 | — | — | — | 1.0 | — | 25 | 250 | 25 | 2.1 | Δ | |

As the experiment result is shown in Table 1, it turns out that every example of the embodiment shows excellent weldability.

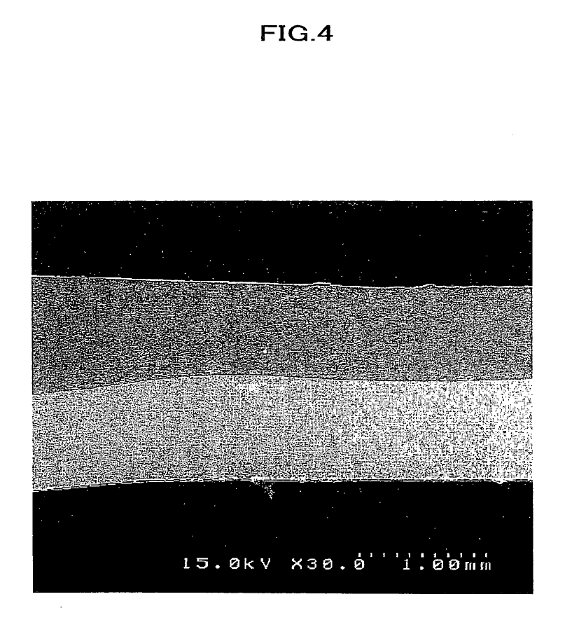

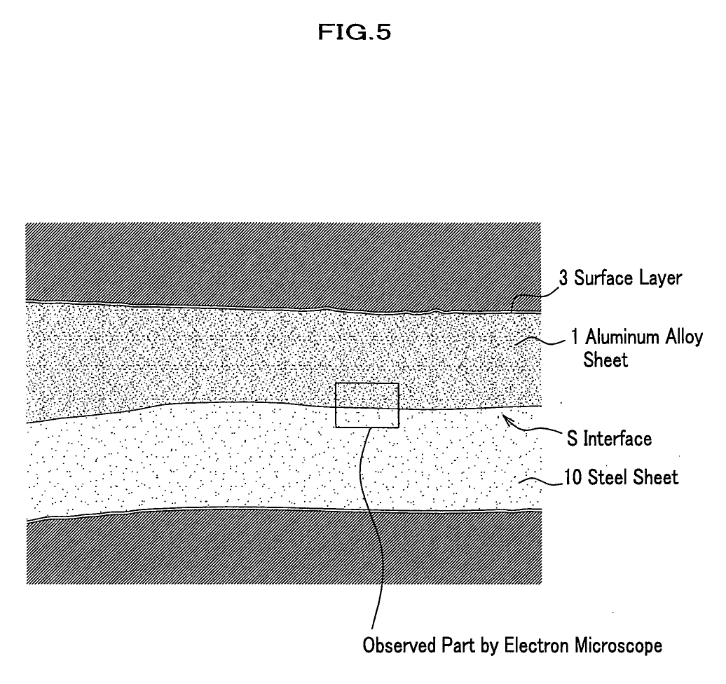

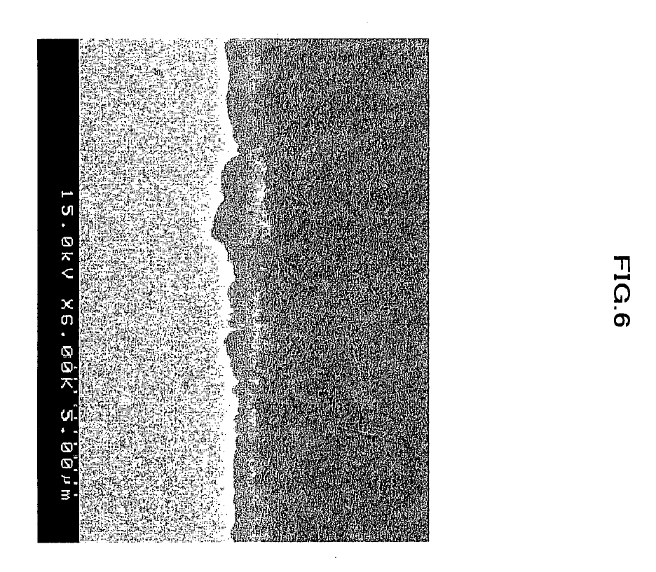

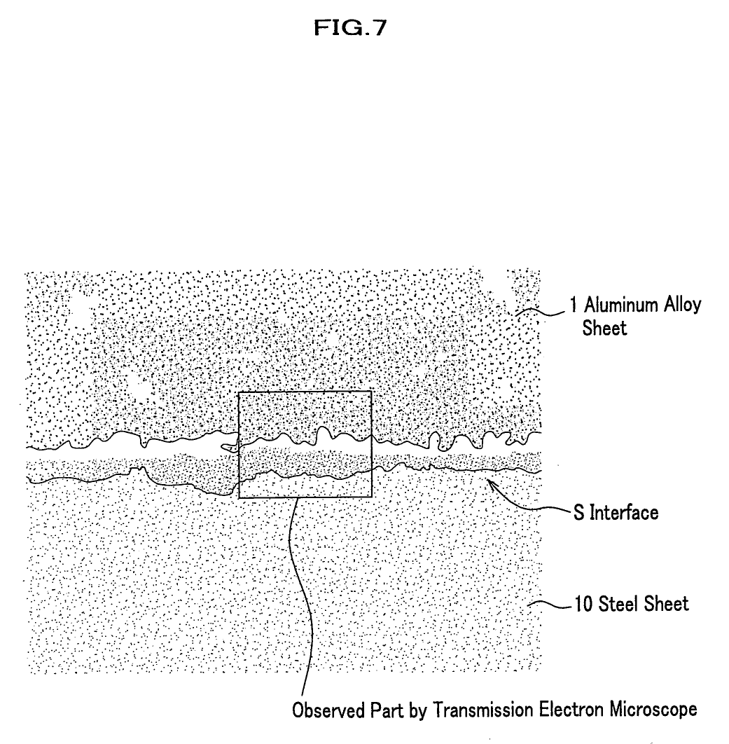

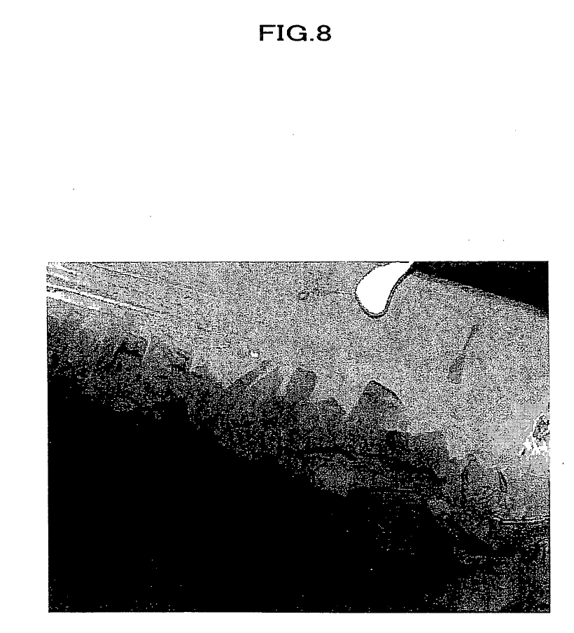

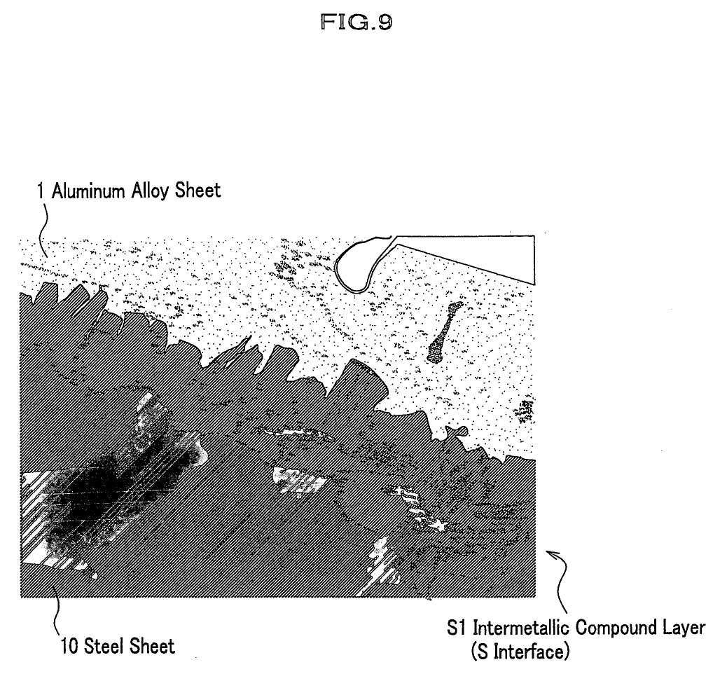

FIG. 4 is a drawing showing a condition of image of a nugget section structure taken by an electron microscope with respect to the example 3 shown in Table 1; FIG. 5 is its schematic drawing. FIG. 6 is an enlarged drawing showing an interface of an aluminum alloy sheet and a steel sheet shown in FIG. 4; FIG. 7 is its schematic drawing. Furthermore, FIG. 8 is a further enlarged drawing showing the interface of FIG. 6 by a transmission electron microscope; FIG. 9 is its schematic drawing. Symbols appended in FIGS. 5, 7, and 9 are same ones described in the embodiment.

Observing these, there exists no plating (surface layer) at the interface S (see FIGS. 4 to 7) of the aluminum alloy sheet 1 and the steel sheet 10, and although an existence of an intermetallic compound layer S1 (see FIGS. 8 and 9) inferred to be produced by the steel sheet 10's diffusing to the side of the aluminum alloy sheet 1 is recognized, it is observed that both are closely contacted.

In addition, a rupture state of a resistance welding member (test piece) thus obtained were examined. Because the welding is spot welding, a welding structure (nugget) becomes a so called round button structure. Watching such the structure finally become what-like rupture state, the structure ruptures in a shape that a portion of the round welding structure completely remains as it is, and in the aluminum alloy sheet 1 is formed a round hole. In other words, it becomes a state that a spot welding portion of the aluminum alloy sheet 1 was brought away to the iron side in the rupture, and it is recognized that a member's rupture occurs in a portion around the round welding structure. Here, if such the member's rupture does not occur, it is foreseen that a separation occurs at the interface of the aluminum alloy sheet 1 and the steel sheet 10 and that the member ruptures from the interface. However, because the member's rupture occurs as described above, practically it is inferred that the spot welding was performed by strength surpassing that of the member around.

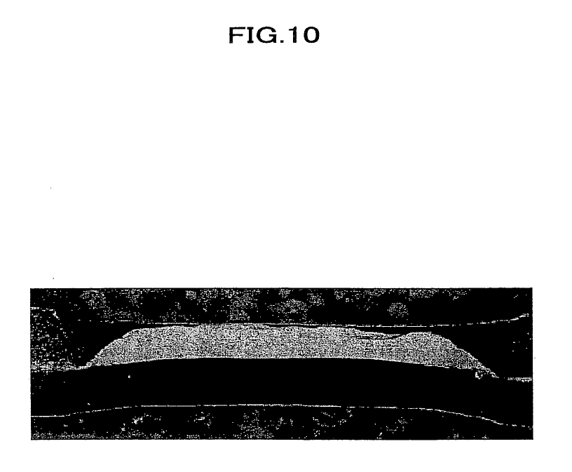

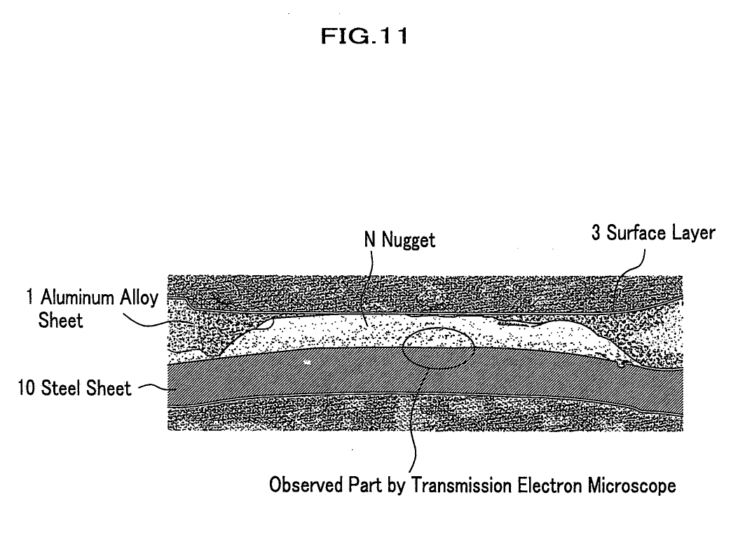

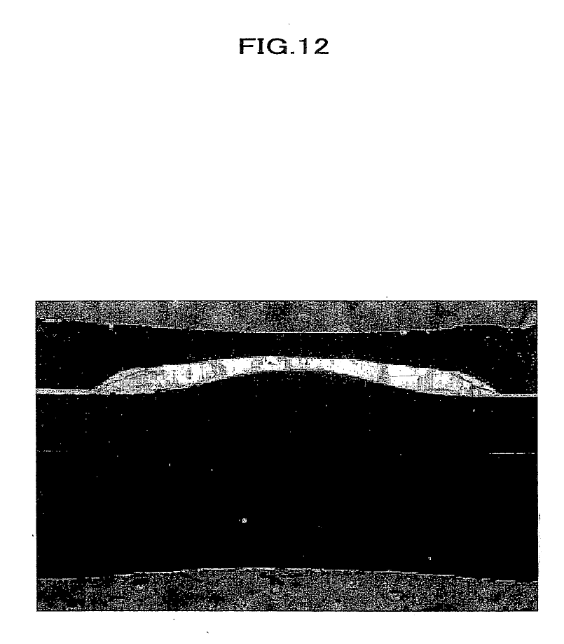

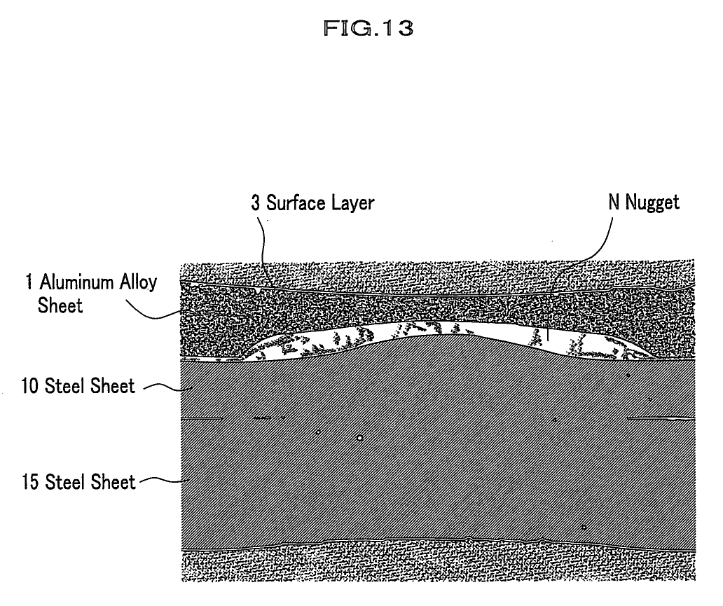

In addition, FIG. 10 is a drawing showing a condition of image of a whole nugget section structure taken by an electron microscope; FIG. 11 is a schematic drawing of FIG. 10. Furthermore, FIG. 12 is a drawing showing a condition of image of a whole nugget section structure of spot welding taken by an electron microscope when a three-layer structure is made by stacking two steel sheets on an aluminum alloy sheet in spot welding; FIG. 13 is a schematic drawing of FIG. 12. Symbols appended in FIGS. 11 and 13 are same ones described in the embodiment. In addition, in FIG. 13 a numeral 15 is a second steel sheet overlapped under the steel sheet 10.

As shown in these drawings, it is observed that the aluminum alloy sheet 1 melted by a resistance heat generation at the side of the steel sheet 10, the nugget N produced at the side of the aluminum alloy sheet 1 is recognized, and the steel sheet 10 and the aluminum alloy sheet 1 are connected.

1. A resistance welding method of different kinds of materials for welding an iron material and an aluminum alloy material, the method comprising the steps of:
performing in advance a coating treatment at least to a portion of said aluminum alloy material, where resistance welding is performed, with any of iron and iron-base alloy and forming a surface layer; and
performing resistance welding of said iron material and said aluminum alloy material through the surface layer

2. A resistance welding method of different kinds of materials according to claim 1, wherein said resistance welding is any of spot welding and projection welding.

3. A resistance welding method of different kinds of materials according to claim 1, wherein an Fe containing ratio of said iron-base alloy is not less than 60%.

4. A resistance welding method of different kinds of materials according to claim 2, wherein an Fe containing ratio of said iron-base alloy is not less than 60%.

5. A resistance welding method of different kinds of materials according to claim 1, wherein a thickness of a surface layer of said aluminum alloy material is formed in a range of 0.01 to 40 μm

6. A resistance welding method of different kinds of materials according to claim 2, wherein a thickness of a surface layer of said aluminum alloy material is formed in a range of 0.01 to 40 μm

7. A resistance welding method of different kinds of materials according to claim 3, wherein a thickness of a surface layer of said aluminum alloy material is formed in a range of 0.01 to 40 μm

8. A resistance welding method of different kinds of materials according to claim 4, wherein a thickness of a surface layer of said aluminum alloy material is formed in a range of 0.01 to 40 μm

9. A resistance welding method of different kinds of materials according to claim 1, wherein said iron-base alloy contains at least one kind out of Cr, Zn, Ti, Sn, Ni, Mn, Co, Cu, Mo, and Si.

10. A resistance welding method of different kinds of materials according to claim 2, wherein said iron-base alloy contains at least one kind out of Cr, Zn, Ti, Sn, Ni, Mn, Co, Cu, Mo, and Si.

11. A resistance welding method of different kinds of materials according to claim 3, wherein said iron-base alloy contains at least one kind out of Cr, Zn, Ti, Sn, Ni, Mn, Co, Cu, Mo, and Si.

12. A resistance welding method of different kinds of materials according to claim 4, wherein said iron-base alloy contains at least one kind out of Cr, Zn, Ti, Sn, Ni, Mn, Co, Cu, Mo, and Si.

13. A resistance welding method of different kinds of materials according to claim 5, wherein said iron-base alloy contains at least one kind out of Cr, Zn, Ti, Sn, Ni, Mn, Co, Cu, Mo, and Si.

14. A resistance welding method of different kinds of materials according to claim 6, wherein said iron-base alloy contains at least one kind out of Cr, Zn, Ti, Sn, Ni, Mn, Co, Cu, Mo, and Si.

15. A resistance welding method of different kinds of materials according to claim 7, wherein said iron-base alloy contains at least one kind out of Cr, Zn, Ti, Sn, Ni, Mn, Co, Cu, Mo, and Si.

16. A resistance welding method of different kinds of materials according to claim 8, wherein said iron-base alloy contains at least one kind out of Cr, Zn, Ti, Sn, Ni, Mn, Co, Cu, Mo, and Si.

17. A resistance welding method of different kinds of materials according to claim 1, wherein said iron-base alloy is an Fe—Cr group alloy.

18. A resistance welding method of different kinds of materials according to claim 2, wherein said iron-base alloy is an Fe—Cr group alloy.

19. A resistance welding method of different kinds of materials according to claim 3, wherein said iron-base alloy is an Fe—Cr group alloy.

20. A resistance welding method of different kinds of materials according to claim 4, wherein said iron-base alloy is an Fe—Cr group alloy.

21. A resistance welding method of different kinds of materials according to claim 5, wherein said iron-base alloy is an Fe—Cr group alloy.

22. A resistance welding method of different kinds of materials according to claim 6, wherein said iron-base alloy is an Fe—Cr group alloy.

23. A resistance welding method of different kinds of materials according to claim 7, wherein said iron-base alloy is an Fe—Cr group alloy.

24. A resistance welding method of different kinds of materials according to claim 8, wherein said iron-base alloy is an Fe—Cr group alloy.

25. An aluminum alloy material used for a resistance welding method of different kinds of materials according to claim 1, the material comprising:
a surface layer formed in advance at least at a portion, where resistance welding is performed, by a coating treatment with any of iron and iron-base alloy.

26. An aluminum alloy material used for a resistance welding method of different kinds of materials according to claim 2, the material comprising:
a surface layer formed in advance at least at a portion, where resistance welding is performed, by a coating treatment with any of iron and iron-base alloy.

27. An aluminum alloy material used for a resistance welding method of different kinds of materials according to claim 3, the material comprising:
a surface layer formed in advance at least at a portion, where resistance welding is performed, by a coating treatment with any of iron and iron-base alloy.

28. An aluminum alloy material used for a resistance welding method of different kinds of materials according to claim 4, the material comprising:
a surface layer formed in advance at least at a portion, where resistance welding is performed, by a coating treatment with any of iron and iron-base alloy.

29. An aluminum alloy material used for a resistance welding method of different kinds of materials according to claim 5, the material comprising:
a surface layer formed in advance at least at a portion, where resistance welding is performed, by a coating treatment with any of iron and iron-base alloy.

30. An aluminum alloy material used for a resistance welding method of different kinds of materials according to claim 6, the material comprising:
a surface layer formed in advance at least at a portion, where resistance welding is performed, by a coating treatment with any of iron and iron-base alloy.

31. An aluminum alloy material used for a resistance welding method of different kinds of materials according to claim 7, the material comprising:
a surface layer formed in advance at least at a portion, where resistance welding is performed, by a coating treatment with any of iron and iron-base alloy.

32. An aluminum alloy material used for a resistance welding method of different kinds of materials according to claim 8, the material comprising:
a surface layer formed in advance at least at a portion, where resistance welding is performed, by a coating treatment with any of iron and iron-base alloy.

33. An aluminum alloy material used for a resistance welding method of different kinds of materials according to claim 9, the material comprising:
a surface layer formed in advance at least at a portion, where resistance welding is performed, by a coating treatment with any of iron and iron-base alloy.

34. An aluminum alloy material used for a resistance welding method of different kinds of materials according to claim 10, the material comprising:
a surface layer formed in advance at least at a portion, where resistance welding is performed, by a coating treatment with any of iron and iron-base alloy.

35. An aluminum alloy material used for a resistance welding method of different kinds of materials according to claim 11, the material comprising:
a surface layer formed in advance at least at a portion, where resistance welding is performed, by a coating treatment with any of iron and iron-base alloy.

36. An aluminum alloy material used for a resistance welding method of different kinds of materials according to claim 12, the material comprising:
a surface layer formed in advance at least at a portion, where resistance welding is performed, by a coating treatment with any of iron and iron-base alloy.

37. An aluminum alloy material used for a resistance welding method of different kinds of materials according to claim 13, the material comprising:
a surface layer formed in advance at least at a portion, where resistance welding is performed, by a coating treatment with any of iron and iron-base alloy.

38. An aluminum alloy material used for a resistance welding method of different kinds of materials according to claim 14, the material comprising:
a surface layer formed in advance at least at a portion, where resistance welding is performed, by a coating treatment with any of iron and iron-base alloy.

39. An aluminum alloy material used for a resistance welding method of different kinds of materials according to claim 15, the material comprising:
a surface layer formed in advance at least at a portion, where resistance welding is performed, by a coating treatment with any of iron and iron-base alloy.

40. An aluminum alloy material used for a resistance welding method of different kinds of materials according to claim 16, the material comprising:
a surface layer formed in advance at least at a portion, where resistance welding is performed, by a coating treatment with any of iron and iron-base alloy.

41. A resistance welding member of different kinds of materials of an iron material and aluminum alloy material obtained by using a resistance welding method of the different kinds of the materials according to claim 1, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

42. A resistance welding member of different kinds of materials of an iron material and aluminum alloy material obtained by using a resistance welding method of the different kinds of the materials according to claim 2, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

43. A resistance welding member of different kinds of materials of an iron material and aluminum alloy material obtained by using a resistance welding method of the different kinds of the materials according to claim 3, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

44. A resistance welding member of different kinds of materials of an iron material and aluminum alloy material obtained by using a resistance welding method of the different kinds of the materials according to claim 4, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

45. A resistance welding member of different kinds of materials of an iron material and aluminum alloy material obtained by using a resistance welding method of the different kinds of the materials according to claim 5, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

46. A resistance welding member of different kinds of materials of an iron material and aluminum alloy material obtained by using a resistance welding method of the different kinds of the materials according to claim 6, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

47. A resistance welding member of different kinds of materials of an iron material and aluminum alloy material obtained by using a resistance welding method of the different kinds of the materials according to claim 7, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

48. A resistance welding member of different kinds of materials of an iron material and aluminum alloy material obtained by using a resistance welding method of the different kinds of the materials according to claim 8, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

49. A resistance welding member of different kinds of materials of an iron material and aluminum alloy material obtained by using a resistance welding method of the different kinds of the materials according to claim 9, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

50. A resistance welding member of different kinds of materials of an iron material and aluminum alloy material obtained by using a resistance welding method of the different kinds of the materials according to claim 10, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

51. A resistance welding member of different kinds of materials of an iron material and aluminum alloy material obtained by using a resistance welding method of the different kinds of the materials according to claim 11, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

52. A resistance welding member of different kinds of materials of an iron material and aluminum alloy material obtained by using a resistance welding method of the different kinds of the materials according to claim 12, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

53. A resistance welding member of different kinds of materials of an iron material and aluminum alloy material obtained by using a resistance welding method of the different kinds of the materials according to claim 13, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

54. A resistance welding member of different kinds of materials of an iron material and aluminum alloy material obtained by using a resistance welding method of the different kinds of the materials according to claim 14, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

55. A resistance welding member of different kinds of materials of an iron material and aluminum alloy material obtained by using a resistance welding method of the different kinds of the materials according to claim 15, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.

56. A resistance welding member of different kinds of materials of an iron material and aluminum alloy material obtained by using a resistance welding method of the different kinds of the materials according to claim 16, the member comprising:
a surface layer formed in advance at least at a portion of said aluminum alloy material, where resistance welding is performed, by a coating treatment with any of iron and iron-base alloy,
wherein said iron material and said aluminum alloy material are welded by the resistance welding through the surface layer.
